(19) United States
(12) Patent Application Publication
(10) Pub. No.: US 2023/0146126 A1
(43) Pub. Date: May 11, 2023

(54) Product Dispensing System and Method

(71) Applicant: Vend Technologies, Inc, Glendale, CA (US)

(72) Inventors: Edvin Sarkisian, Burbank, CA (US); Shant Jacob Sarkisian, Glendale, CA (US); NAREK MIKAELYAN, BURBANK, CA (US)

(73) Assignee: VEND TECHNOLOGIES, INC, GLENDALE, CA (US)

(21) Appl. No.: 17/985,042

(22) Filed: Nov. 10, 2022

Related U.S. Application Data
(60) Provisional application No. 63/277,631, filed on Nov. 10, 2021.

(51) Int. Cl. G07F 9/00; G07F 9/02

(52) U.S. Cl. CPC G07F 9/009; G07F 9/006; G07F 9/026

(57) ABSTRACT

A system is provided that authenticates the identity and age of a user, that offers at least one age-restricted product for sale to the user, that enables the user to purchase the at least one product via a mobile application, that provides the at least one purchased product at a physical product locker at a location convenient to the user to travel to, that again authenticates the identity and age of the user at the physical location of the product locker prior to dispensing the product, and that, upon authentication of the user’s identity and age, releases the product to the user.

### CROSS-REFERENCE TO RELATED APPLICATIONS

This application claims priority to U.S. Provisional Pat. Application No. 63/227,631 filed on Nov. 10, 2021, the entire contents of which are hereby fully incorporated herein by reference for all purposes.

### COPYRIGHT STATEMENT

This patent document contains material subject to copyright protection. The copyright owner has no objection to the reproduction of this patent document or any related materials in the files of the United States Patent and Trademark Office, but otherwise reserves all copyrights whatsoever.

### FIELD OF THE INVENTION

This invention relates to product dispensing systems and methods, including automated product dispensing systems configured with a mobile application and identity confirmation technology.

### BACKGROUND

As is known, many products throughout the world are restricted from minors (e.g., customers under the age of 18 or 21). These products may be deemed to be potentially harmful to younger customers, and may include, e.g., tobacco products, alcohol products, and other types of products.

As an example, it is a well-known fact that some tobacco resellers have a high rate of selling tobacco products to underage individuals. This problem may be due to negligence or indifference of the reseller, fake identification cards, and other reasons.

Accordingly, there is a need for a system and method to verify the identity and age of a potential customer prior to enabling the customer to purchase restricted items. There also is a need for a system that provides this service at automated product lockers in convenient locations to its potential customers.

### BRIEF DESCRIPTION OF THE DRAWINGS

Other objects, features, and characteristics of the present invention as well as the methods of operation and functions of the related elements of structure, and the combination of parts and economies of manufacture, will become more apparent upon consideration of the following description and the appended claims with reference to the accompanying drawings, all of which form a part of this specification. None of the drawings are to scale unless specifically stated otherwise.

FIG. 1 shows an overview of a product dispensing system framework in accordance with exemplary embodiments hereof;

FIG. 2 shows aspects of a product dispensing system in accordance with exemplary embodiments hereof;

FIG. 3 shows actions taken by a user and/or by a product dispensing system in accordance with exemplary embodiments hereof;

FIG. 4 shows aspects of a product dispensing system in accordance with exemplary embodiments hereof; and

FIG. 5 depicts aspects of computing and computer devices in accordance with exemplary embodiments hereof.

### DETAILED DESCRIPTION OF EXEMPLARY EMBODIMENTS

In general, the system according to exemplary embodiments hereof provides a system that authenticates the identity and age of a user, that offers at least one product for sale to the user, that enables the user to purchase the at least one product via a mobile application, that provides the at least one purchased product at a physical product locker at a location convenient to the user to travel to, that again authenticates the identity and age of the user at the location of the product locker, and that, upon authentication of the user’s identity and age, releases the product to the user.

For the purposes of this specification, the system will be described primarily in regard to its use dispensing tobacco products to a user upon authenticating the user’s identity and age. However, it is understood that the system may be used to dispense any type(s) of products (e.g., for sale, for pickup, etc.) and that the scope of the system is not limited in any way by the types of products that it dispenses. For example, the system may be used to dispense cannabis products, CBD products, pharmaceuticals, adult-consumable products, other types of age-restricted products, other types of products that may benefit from identity and/or age verification, and any combinations thereof.

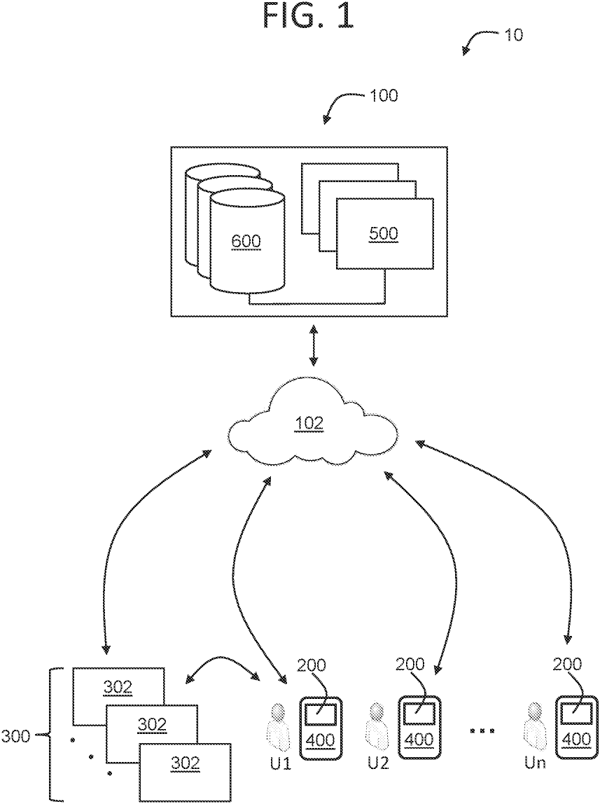

FIG. 1 shows an overview of an exemplary framework for a product dispensing system 10 (also referred to simply as the system 10) according to exemplary embodiments hereof. As shown, the product dispensing system 10 may include a backend system 100 that may interface with an application 200 (e.g., a mobile application or “app”, a website viewed using a browser, a desktop application, or other types of applications), and a product dispensing system 300. The interface may include a network 102 (e.g., the Internet, LAN, WAN, etc.), wireless communication systems, cellular communication systems, telephony or other types of communication systems or protocols.

The system 10 may be accessed by multiple users U1, U2, ... Un via the network 102 and using the mobile application 200 running on one or more computing devices 400 (e.g., smart phones, tablet computers, laptops, desktop computers, mobile media players, other types of client devices, etc.).

In some embodiments, the application 200 may display one or more graphical user interfaces (GUIs) on the display(s) of associated electronic devices 400. In some embodiments, the application 200 may provide different GUIs to different types of users Un depending on the needs and desires of each respective user Un (e.g., depending on the types of products that a particular user Un may wish to purchase). The GUIs may be provided through the mobile application 200 running on a personal electronics device 400, through a website portal or dashboard 200, through a desktop application 200, and/or through other types of applications 200, depending on the user Un and the device 400.

In some embodiments, the backend system 100 may include a cloud platform (e.g., one or more backend servers), one or more local controllers, or any combination thereof. In some embodiments, the backend system 100 includes a cloud platform that interfaces with one or more local controllers. For example, administrators of the system 10 may interface with the system 10 via a local controller in communication with a cloud platform.

The backend system 100 may include one or more applications 500 and one or more databases 600 as will be described in other sections.

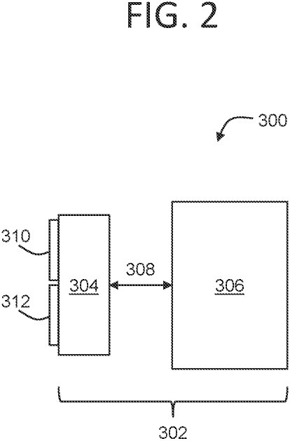

In some embodiments as shown in FIG. 2, the product dispensing system 300 may include one or more product dispensing units 302. Each product dispensing unit 302 preferably includes a product locker 304 configured with a product inventory system 306 via a product fulfillment channel 308. The product locker 304 also may include an interface 310 with which to communicate and/or otherwise interact with a user Un, and a product release mechanism 312 that releases (dispenses) a product to the user Un after the purchase and identity and age confirmation process(es) have been completed (as described herein). In some embodiments, it is preferable that each product dispensing unit 302 and each product locker 304 be automated, however, some manual intervention may be required under certain circumstances.

In some embodiments, the product inventory system 306 stocks and stores inventory of the one or more products that the system 10 provides for sale to its users Un. In the example of providing tobacco products, the product inventory system 306 may stock different brands of cigarettes, cigars, vape units, and/or other types of smokables from different suppliers to be purchased. In this way, a user Un may choose which product (e.g., brand of cigarette) he/she may wish to purchase and the system 10, having stock of the product, may be equipped to provide it.

In some embodiments, the product inventory system 306 is configured with the product locker 304 via a product fulfillment channel 308 that is equipped to transfer a product being purchased by the user Un from the product inventory system 306 to the product locker 304 to be released. The product fulfillment channel 308 also may be equipped to move the product from the locker 304 back to the inventory system 306 for restocking, e.g., if and when a purchase process may fail.

In some embodiments, the product inventory system 306 may be physically configured at the same location as the product locker 304 such that the product fulfillment channel 308 may include a mechanical mechanism configured to move the product(s) from the inventory system 306 to the locker 304. In this example, the product fulfillment system 308 may include a conveyer belt, a robotic arm, a channel, a shoot, a slide, a mover, any other mechanical type of moving mechanism, and any combinations thereof. In some embodiments, the movement of the product(s) may not include manual intervention and in other embodiments, manual intervention may be included.

In some embodiments, the inventory system 306 may be integrated directly into the product locker 304 such that the product(s) are simply held within the locker 304 until they are purchased. In other embodiments, the inventory system 306 may reside in the same enclosure as the product locker 304 but behind a sealed and/or locked partition (e.g., behind a steel wall in the back of the locker 304) such that the product(s) are inaccessible. In this way, even if the product locker 304 were to be tampered with (e.g., broken open), access to the product(s) within the inventory system 306 would be prevented.

In some embodiments, the product inventory system 306 may be configured at a different location than the product locker 304 such that the product fulfillment channel 308 may include a delivery service (automated and/or manual), and/or any other type of fulfillment channel 308. In any event, it is understood that the fulfillment channel 308 may include any type of system and/or mechanism to transport a product in real time from the inventory system 306 to the locker 304 (e.g., for purchase), and/or from the locker 304 to the inventory system 306 (e.g., for restocking).

In some embodiments as shown in FIG. 2, the product locker 304 includes an interface 310 equipped to interact with the user Un during the identity and age confirmation and/or product purchase processes. The interface 310 may include any type of interface, such as, without limitation, a touchscreen, a display, control mechanisms (e.g., buttons, knobs, etc.), a camera, other types of interfaces, and/or any combinations thereof. As will be described in other sections, the interface 310 may provide user identity and/or age verification functionalities that may be required to complete the purchase process.

In some embodiments as shown in FIG. 2, the product locker 304 includes a product release mechanism 312 that releases the purchased product to the user Un at the completion of the identity and age confirmation and purchase processes. The product release mechanism 312 may include a door that opens thereby allowing the user Un to physically remove the product from within the locker 304, a delivery arm that hands the product to the user Un, a slot that the product may be positioned within to enable the user Un to remove the product, any other type of product release mechanisms 312, and any combinations thereof.

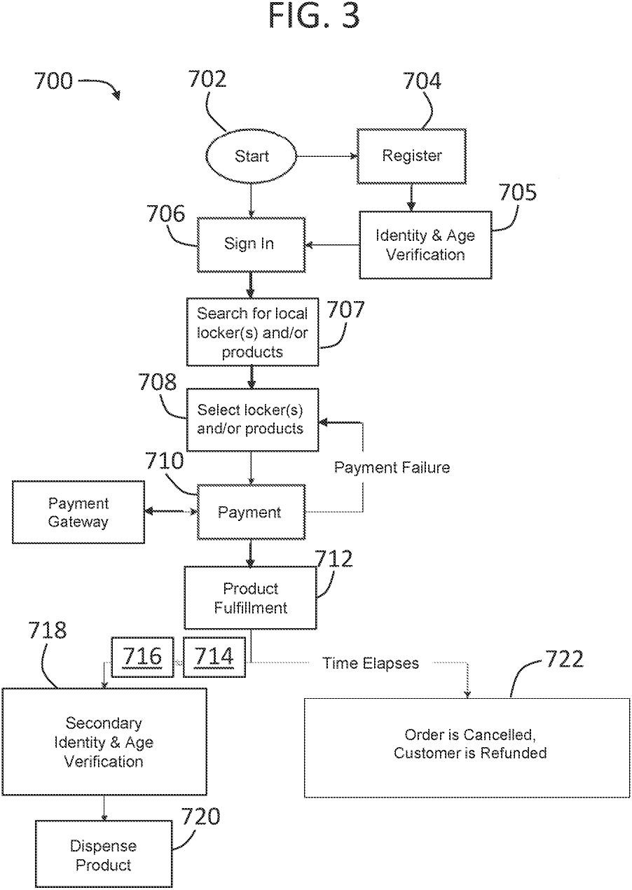

FIG. 3 shows an overview of workflow actions 700 that demonstrate the functionalities of the system 10 as it interacts with a user Un.

First (at 702), the system 10 provides an application 200 to the user Un. In order to utilize the system 10, the application 200 preferably requires the user Un to register with the system 10 (at 704), wherein the registration process includes a primary user identity and age verification process (e.g., at 705). For example, in some embodiments, the user Un is required to provide the system 10 with government-issued documents that show the user’s identity such as a driver’s license, a passport, a government identification card, other types of documentation, and/or any combinations thereof. In another example, in some embodiments, the user Un may be required to take a photograph of the identification document(s) and to upload the photograph(s) to the system 10 for verification. The user Un also may be required to provide one or more real-time biometric artifacts to the system 10, e.g., the user Un may be required to take a selfie of himself/herself in real time (e.g., using the application 200 running on his/her electronic device 400) and to provide (upload) the selfie to the system 10. Other types of biometric information also may be used, such as, but not limited to, fingerprint(s), retinal scan, voice verification, other types of biometric information, and any combinations thereof. The system 10 may then compare the identity documents with the selfie (e.g., using biometric identification technologies such as facial recognition) to confirm the user’s identity and age. Once verified, the user’s biometric information (e.g., facial recognition information and associated identity documents and/or photographs thereof) may be stored by the system 10 for future use (e.g., to verify the real time identity of the user Un when he/she interfaces with the product locker’s interface 310 to retrieve a product). Other suitable types of identity and/or age verification processes also may be used, including, and not limited to, third party applications.

Once a user Un has registered with the system 10 and the system 10 has provided the user Un with a registered system account, the user Un may log into the system 10 (at 706). The log-in process also may include a secondary identity verification process including, but not limited to, a biometric verification (e.g., facial recognition, fingerprint recognition, etc.), password, verification code messaging, any other suitable real time identification verification methodologies, and any combinations thereof. In some embodiments, at least some of the verification functionalities may be provided by the smart device 400, by the application 200, by the backend system 100, by other means, and by any combinations thereof.

Once logged in, a user Un (at 707) may use the application 200 to search for local product lockers 304 to purchase from and/or browse the product listings offered for sale by the system 10. In some embodiments, if the user Un chooses a particular product of interest without identifying a particular locker 304, the application 200 may determine which local product lockers 304 in proximity to the user Un (e.g., within a chosen radius) may offer the specific product such that the user Un may understand where he/she must travel to acquire the desired product. In some embodiments, the system 10 may include a geolocation and navigation system (e.g., a Global Positioning System (GPS)) that may identify the physical location of the user Un (e.g., of the user’s device 400) to determine product locker(s) 304 within close proximity to the user Un for the transaction to take place. If the product the user Un is interested in is available from a locker 304 close to the user Un, the user Un may simply choose that locker 304 to purchase from. If, however, the product of interest is not available at a locker 304 in close proximity, the user Un may choose a different product and the process may repeat. This may continue until the user Un finds a desired product in inventory at a product locker 304 within a desired radius of his/her location.

In other embodiments, prior to the user Un choosing a product of interest, the application 200 may provide the user Un with a list of local product lockers 304 including each locker’s respective location with respect to the user Un (e.g., on a graphical map showing the user’s location and the locations of the lockers 304), and the user Un may choose a particular locker 304 to browse. The user Un may then browse the products available for sale at the chosen locker 304 to determine a product of interest.

Next, at 708, the user Un may then select a locker location (if the locker 304 has not already been chosen on his/her behalf by the system 10) and/or one or more product(s) to purchase from the chosen locker 304. At 710, the user Un may pay for the product using a payment method supported by the system 10 (e.g., credit card, debit card, PayPal, etc.). If the payment is successful, the system 10 confirms this with the user Un (e.g., on the application 200) and the process moves to the fulfillment phase (at 712). If, however, the payment is not successful, the user Un is notified of the payment failure, and the process returns to 708.

Next, once the payment process has been successfully completed, the system 10 (e.g., the product dispensing system 300) may confirm one or more locker 304 locations for the user Un to receive the purchased product(s). This may include the same locker 304 that the user Un identified in step 707 as well as additional lockers 304 in the vicinity of the user Un that also stock the product of interest. In some embodiments, the system 10 may use its geolocation and navigation system and display a map showing the location of the user Un and the respective locations of the lockers 304, including travel directions and preferred routes for the user Un to take. In some embodiments, the system 10 may notify the user Un of the preferred locker(s) 304 location(s) (e.g., the lockers 304 in closest proximity to the user Un) and the user Un may confirm which one of the location(s) will be used (e.g., by clicking on the preferred locker 304 on the map). Other methods of identifying and/or choosing a locker 304 for product pick-up also may be utilized (e.g., based on product availability and/or inventory supply at different lockers 304 and/or inventory systems 306.

Once a locker 304 has been chosen for the transaction, the system 10 identifies the purchased product(s) in the inventory system 306 and moves the purchased product(s) from the inventory system 306 to the chosen product locker 304 using the product fulfillment channel 308 (at 714). If the purchased product(s) are already located within the locker 304, fulfillment of the product(s) from the inventory system 306 to the locker 304 may not be necessary.

Subsequently, and/or in parallel (at 716), the system 10 may send the user Un a confirmation message (e.g., a receipt) to his/her user device 400 while notifying the user Un that the product is ready for pickup at the designated locker 304. Other instructions also may be included in the message.

At this stage, the user Un may travel to the product locker 304 or otherwise physically position themselves at the location of the locker 304 in preparation to receive the product. In some embodiments (at 718), the system 10 may then perform a secondary user identity and age verification process to confirm that the user Un at the locker location is in fact the user Un who ordered and paid for the product(s) via the application 200. In some embodiments, the system 10 via the product locker 304 may present the user Un a unique code (e.g., a unique QR code on its interface 310) and instruct the user Un to scan (or input) the code using the application 200 running on his/her device 400. Once scanned (or otherwise entered), the system 10 may correlate the scanned code with the application 200 running on the user’s device 400 to confirm that the device 400 at the locker location corresponds to the device 400 that the user Un used to purchase the product(s) moments earlier via the application 200.

Next, in some embodiments, the system 10 may verify the user himself/herself. In some embodiments, the system 10 may instruct the user Un to take a selfie (i.e., a picture of themselves) using the application 200 running on their device 400. In some embodiments, the application 200 may control the device’s camera to take the selfie and the system 10 may use facial recognition technology (either on the device 400 and/or at the backend 100) to confirm that the person in the selfie matches the person whose identity was verified in the primary identity verification step 705.

It is understood that additional and/or other suitable identity verification methods also may be used (e.g., other types of biometrics using the locker’s interface 310 and/or the user’s device 400, texting a verification code to the user’s device 400 and asking the user Un to enter the code into the interface 310, etc.). In any event, the system 10 may verify that it is in fact the registered user Un at the locker 304 prior to dispensing the purchased product.

Once the user’s identity has been verified, the system 10 may release the purchased product to the user Un using the product release mechanism 312 (at 720). The user Un may receive the product and the system 10 may provide the user Un a receipt of the transaction (via the application 200, the locker interface 310, a printed receipt, etc.).

If the identity verification process in 718 fails for any reason, the user Un may be notified, and the product may not be released by the locker 304. If the identity verification failure is not rectified, the product may not be released, and/or may be physically moved from the locker 304 to the inventory system 306 by the fulfillment channel 308 for restocking (if necessary).

In some embodiments, the system 10 may impose a time limit from when the payment is received to when the user Un presents himself/herself at the locker 304 to receive the product (e.g., when the user Un scans the QR code on the locker interface 310). For example, in some embodiments, the system 10 may require that the user Un present themselves at the locker 304 for identity verification (at 718) within 5 minutes of the purchase transaction (at 712). If the user Un does not present themselves at the locker 304 within this time limit, the purchase may be cancelled (at 722), the user Un may be refunded the purchase price, and the product may be returned to inventory 308.

It is understood that the actions described above are meant for demonstration and are non-limiting, that the system 10 may perform other actions not described, and/or not all of the actions 700 listed may necessarily be performed. It is also understood that the system 10 may perform the actions 700 in other orders.

### System Structure

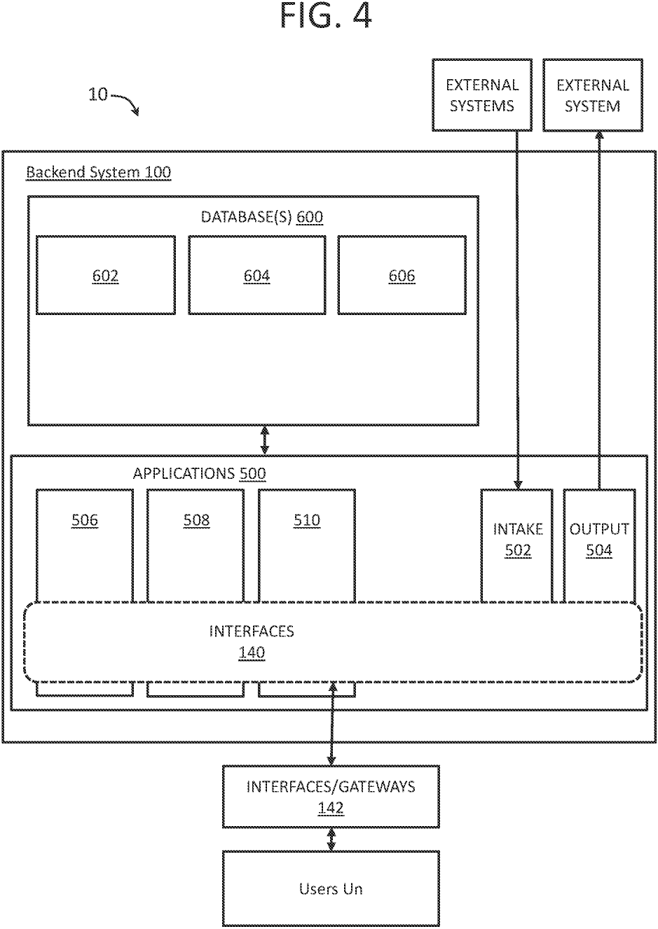

FIG. 4 shows aspects of an exemplary transportation dating system 10 of FIG. 1. As shown, the system 10 and backend system 100 comprises various internal applications 500 and one or more databases 600, described in greater detail below. The internal applications 500 may generally interact with the one or more databases 600 and the data stored therein.

The database(s) 600 may comprise one or more separate or integrated databases, at least some of which may be distributed. The database(s) 600 may be implemented in any manner, and, when made up of more than one database, the various databases need not all be implemented in the same way. It should be appreciated that the system is not limited by the nature or location of database(s) 106 or by the manner in which they are implemented.

Each of the internal applications 500 may provide one or more services via an appropriate interface. Although shown as separate applications 500 for the sake of this description, it is appreciated that some or all of the various applications 500 may be combined. The various applications 500 may be implemented in any manner and need not all be implemented in the same way (e.g., using the same software languages, interfaces, or protocols).

In some embodiments, the applications 500 may include one or more of the following applications 500:
1. Data input application(s) 502. This application may input any type of data from the application 200 and/or from external systems (e.g., third party entities) and/or other systems as necessary for the system 10 to perform its functionalities.
2. Data output application(s) 504. This application may output any type of data to any applicable system and/or element such as the application 200, external entities (e.g., third party entities), any other system and/or element and any combination thereof.
3. Identity Verification application(s) 506. This application may include any and all of the applications necessary to verify the identity and/or age of the users Un during use of the system 10.
4. Product fulfillment application(s) 508. This application may manage the sale and fulfillment of any product to a user Un through use of the system 10. This application also may include a GPS application to track the location of the users Un with respect to the locations of the respective product lockers 304.
5. Miscellaneous applications 510. These applications may provide additional functionalities of any addition workflow requirements of the system 10.

The applications 500 also may include other applications and/or auxiliary applications (not shown). Those of ordinary skill in the art will appreciate and understand, upon reading this description, that the above list of applications is meant for demonstration and that the system 10 may include other applications that may be necessary for the system 10 to generally perform its functionalities as described in this specification. In addition, as should be appreciated, embodiments or implementations of the system 10 need not include all of the applications listed, and that some or all of the applications may be optional. It is also understood that the scope of the system 10 is not limited in any way by the applications that it may include.

In some embodiments, the database(s) 600 may include one or more of the following databases 600:
1. User information database(s) 602. This database may store any registration and/or profile information for any user Un of the system 10. This information also may include any information used to verify the users’ identities, and/or other user information required by the system 10.
2. Usage history database(s) 604. This database may store any type of historical data pertaining to any transactions taken by any users Un. The stored information may be used for any purposes including, but not limited to, inventory tracking, reporting, audits, targeted sales and marketing efforts, etc.
3. Miscellaneous databases 606. These databases may store any other data required by the system 10.

It is understood that the above list of databases is meant for demonstration and that the system 10 may include some or all of the databases, and also may include additional databases as required. It is also understood that the scope of the system 10 is not limited in any way by the databases that it may include.

Various applications 500 and databases 600 in the system 10 may be accessible via interface(s) 142. These interfaces 142 may be provided in the form of APIs or the like and made accessible to external users Un via one or more gateways and interfaces 144 (e.g., via a web-based application 200 and/or a mobile application 200 running on a client’s personal device 400 such as a mobile phone, tablet computer, desktop computer, laptop computer, etc.).

It is understood that any aspect and/or element of any embodiment described herein or otherwise may be combined in any way to form additional embodiments all of which are easily understood by a person of ordinary skill in the art and all of which are within the scope of the system 10.

Those of ordinary skill in the art will appreciate and understand, upon reading this description, that embodiments hereof may provide different and/or other advantages, and that not all embodiments or implementations need have all advantages.

### Computing

The services, mechanisms, operations, and acts shown and described above are implemented, at least in part, by software running on one or more computers or computer systems or devices. It should be appreciated that each user device is, or comprises, a computer system.

Programs that implement such methods (as well as other types of data) may be stored and transmitted using a variety of media (e.g., computer readable media) in a number of manners. Hard-wired circuitry or custom hardware may be used in place of, or in combination with, some or all of the software instructions that can implement the processes of various embodiments. Thus, various combinations of hardware and software may be used instead of software only.

One of ordinary skill in the art will readily appreciate and understand, upon reading this description, that the various processes described herein may be implemented by, e.g., appropriately programmed general purpose computers, special purpose computers and computing devices. One or more such computers or computing devices may be referred to as a computer system.

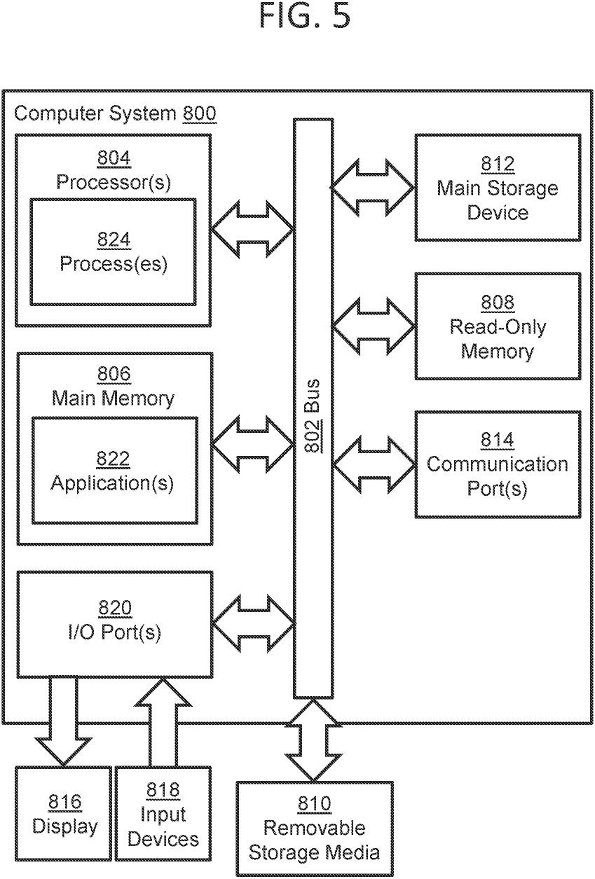

FIG. 5 is a schematic diagram of a computer system 800 upon which embodiments of the present disclosure may be implemented and carried out.

According to the present example, the computer system 800 includes a bus 802 (i.e., interconnect), one or more processors 804, one or more communications ports 814, a main memory 806, removable storage media 810, read-only memory 808, and a mass storage 812. Communication port(s) 814 may be connected to one or more networks by way of which the computer system 800 may receive and/or transmit data.

As used herein, a “processor” means one or more microprocessors, central processing units (CPUs), computing devices, microcontrollers, digital signal processors, or like devices or any combination thereof, regardless of their architecture. An apparatus that performs a process can include, e.g., a processor and those devices such as input devices and output devices that are appropriate to perform the process.

Processor(s) 804 can be (or include) any known processor, such as, but not limited to, an Intel® Itanium® or Itanium 2® processor(s), AMD® Opteron® or Athlon MP® processor(s), or Motorola® lines of processors, and the like. Communications port(s) 814 can be any of an RS-232 port for use with a modem-based dial-up connection, a 10/100 Ethernet port, a Gigabit port using copper or fiber, or a USB port, and the like. Communications port(s) 814 may be chosen depending on a network such as a Local Area Network (LAN), a Wide Area Network (WAN), a CDN, or any network to which the computer system 800 connects. The computer system 800 may be in communication with peripheral devices (e.g., display screen 816, input device(s) 818) via Input / Output (I/O) port 820. Some or all of the peripheral devices may be integrated into the computer system 800, and the input device(s) 818 may be integrated into the display screen 816 (e.g., in the case of a touch screen).

Main memory 806 can be Random Access Memory (RAM), or any other dynamic storage device(s) commonly known in the art. Read-only memory 808 can be any static storage device(s) such as Programmable Read-Only Memory (PROM) chips for storing static information such as instructions for processor(s) 804. Mass storage 812 can be used to store information and instructions. For example, hard disks such as the Adaptec® family of Small Computer Serial Interface (SCSI) drives, an optical disc, an array of disks such as Redundant Array of Independent Disks (RAID), such as the Adaptec® family of RAID drives, or any other mass storage devices may be used.

Bus 802 communicatively couples processor(s) 804 with the other memory, storage and communications blocks. Bus 802 can be a PCI / PCI-X, SCSI, a Universal Serial Bus (USB) based system bus (or other) depending on the storage devices used, and the like. Removable storage media 810 can be any kind of external hard-drives, floppy drives, IOMEGA® Zip Drives, Compact Disc - Read Only Memory (CD-ROM), Compact Disc - Re-Writable (CD-RW), Digital Versatile Disk - Read Only Memory (DVD-ROM), etc.

Embodiments herein may be provided as one or more computer program products, which may include a machine-readable medium having stored thereon instructions, which may be used to program a computer (or other electronic devices) to perform a process. As used herein, the term “machine-readable medium” refers to any medium, a plurality of the same, or a combination of different media, which participate in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random-access memory, which typically constitutes the main memory of the computer. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications.

The machine-readable medium may include, but is not limited to, floppy diskettes, optical discs, CD-ROMs, magneto-optical disks, ROMs, RAMs, erasable programmable read-only memories (EPROMs), electrically erasable programmable read-only memories (EEPROMs), magnetic or optical cards, flash memory, or other type of media/machine-readable medium suitable for storing electronic instructions. Moreover, embodiments herein may also be downloaded as a computer program product, wherein the program may be transferred from a remote computer to a requesting computer by way of data signals embodied in a carrier wave or other propagation medium via a communication link (e.g., modem or network connection).

Various forms of computer readable media may be involved in carrying data (e.g., sequences of instructions) to a processor. For example, data may be (i) delivered from RAM to a processor; (ii) carried over a wireless transmission medium; (iii) formatted and/or transmitted according to numerous formats, standards or protocols; and/or (iv) encrypted in any of a variety of ways well known in the art.

A computer-readable medium can store (in any appropriate format) those program elements that are appropriate to perform the methods.

As shown, main memory 806 is encoded with application(s) 822 that support(s) the functionality as discussed herein (an application 822 may be an application that provides some or all of the functionality of one or more of the mechanisms described herein). Application(s) 822 (and/or other resources as described herein) can be embodied as software code such as data and/or logic instructions (e.g., code stored in the memory or on another computer readable medium such as a disk) that supports processing functionality according to different embodiments described herein.

During operation of one embodiment, processor(s) 804 accesses main memory 806 via the use of bus 802 in order to launch, run, execute, interpret or otherwise perform the logic instructions of the application(s) 822. Execution of application(s) 822 produces processing functionality of the service(s) or mechanism(s) related to the application(s). In other words, the process(es) 824 represents one or more portions of the application(s) 822 performing within or upon the processor(s) 804 in the computer system 800.

It should be noted that, in addition to the process(es) 824 that carries(carry) out operations as discussed herein, other embodiments herein include the application 822 itself (i.e., the un-executed or non-performing logic instructions and/or data). The application 822 may be stored on a computer readable medium (e.g., a repository) such as a disk or in an optical medium. According to other embodiments, the application 822 can also be stored in a memory type system such as in firmware, read only memory (ROM), or, as in this example, as executable code within the main memory 806 (e.g., within Random Access Memory or RAM). For example, application 822 may also be stored in removable storage media 810, read-only memory 808, and/or mass storage device 812.

Those skilled in the art will understand that the computer system 800 can include other processes and/or software and hardware components, such as an operating system that controls allocation and use of hardware resources.

As discussed herein, embodiments of the present invention include various steps or operations. A variety of these steps may be performed by hardware components or may be embodied in machine-executable instructions, which may be used to cause a general-purpose or special-purpose processor programmed with the instructions to perform the operations. Alternatively, the steps may be performed by a combination of hardware, software, and/or firmware. The term “module” refers to a self-contained functional component, which can include hardware, software, firmware, or any combination thereof.

One of ordinary skill in the art will readily appreciate and understand, upon reading this description, that embodiments of an apparatus may include a computer/computing device operable to perform some (but not necessarily all) of the described process.

Embodiments of a computer-readable medium storing a program or data structure include a computer-readable medium storing a program that, when executed, can cause a processor to perform some (but not necessarily all) of the described process.

Where a process is described herein, those of ordinary skill in the art will appreciate that the process may operate without any user intervention. In another embodiment, the process includes some human intervention (e.g., a step is performed by or with the assistance of a human).

As used in this description, the term “portion” means some or all. So, for example, “A portion of X” may include some of “X” or all of “X”. In the context of a conversation, the term “portion” means some or all of the conversation.

As used herein, including in the claims, the phrase “at least some” means “one or more,” and includes the case of only one. Thus, e.g., the phrase “at least some ABCs” means “one or more ABCs”, and includes the case of only one ABC.

As used herein, including in the claims, the phrase “based on” means “based in part on” or “based, at least in part, on,” and is not exclusive. Thus, e.g., the phrase “based on factor X” means “based in part on factor X” or “based, at least in part, on factor X.” Unless specifically stated by use of the word “only”, the phrase “based on X” does not mean “based only on X.”

As used herein, including in the claims, the phrase “using” means “using at least,” and is not exclusive. Thus, e.g., the phrase “using X” means “using at least X.” Unless specifically stated by use of the word “only”, the phrase “using X” does not mean “using only X.”

In general, as used herein, including in the claims, unless the word “only” is specifically used in a phrase, it should not be read into that phrase.

As used herein, including in the claims, the phrase “distinct” means “at least partially distinct.” Unless specifically stated, distinct does not mean fully distinct. Thus, e.g., the phrase, “X is distinct from Y” means that “X is at least partially distinct from Y,” and does not mean that “X is fully distinct from Y.” Thus, as used herein, including in the claims, the phrase “X is distinct from Y” means that X differs from Y in at least some way.

As used herein, including in the claims, a list may include only one item, and, unless otherwise stated, a list of multiple items need not be ordered in any particular manner. A list may include duplicate items. For example, as used herein, the phrase “a list of XYZs” may include one or more “XYZs”.

It should be appreciated that the words “first” and “second” in the description and claims are used to distinguish or identify, and not to show a serial or numerical limitation. Similarly, the use of letter or numerical labels (such as “(a)”, “(b)”, and the like) are used to help distinguish and / or identify, and not to show any serial or numerical limitation or ordering.

No ordering is implied by any of the labeled boxes in any of the flow diagrams unless specifically shown and stated. When disconnected boxes are shown in a diagram the activities associated with those boxes may be performed in any order, including fully or partially in parallel.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A method of dispensing an age-restricted product comprising:
(A) receiving, from a user, an image of at least one user age-verifying document and at least one first real-time user biometric artifact;
(B) verifying, by one or more computer systems, based at least in part on the image of the at least one user age-verifying document and/or on the at least one first real-time user biometric artifact, an identity and age of the user;
(C) displaying, on a first client device associated with the user, a listing of at least one age-restricted product for sale by at least one automated product locker;
(D) receiving, from the first client device, an indication of a selection of a first at least one age-restricted product;
(E) displaying, on the first client device, a location of a first at least one automated product locker that has inventory for sale of the first at least one age-restricted product;
(F) receiving payment, by one or more computer systems, from the user for the purchase of the first at least one age-restricted product;
(G) providing, at the at the first at least one automated product lockers, a code unique to the user;
(H) receiving, from the first client device, an input of the code;
(I) verifying, by one or more computer systems, that the code provided in (G) corresponds to the input of the code received in (H);
(J) receiving, from the first client device, at least one second real-time user biometric artifact;
(K) determining, by one or more computer systems, if the at least one first real-time user biometric artifact corresponds to the at least one second real-time user biometric artifact;
(L) in response to a positive determination in (K) that the at least one first real-time user biometric artifact corresponds to the at least one second real-time user biometric artifact, by the first at least one automated product lockers, dispensing the first at least one age-restricted product.

2. The method of claim 1 wherein the at least one first real-time user biometric artifact and the at least one second real-time user biometric artifact each include at least one selfie of the user.

3. The method of claim 1 wherein the first at least one age-restricted product includes a tobacco-related product.

4. The method of claim 1 further comprising:
(E)(1) receiving, from the first client device, an indication of a selection of the first at least one automated product locker.

5. A method of dispensing an age-restricted product comprising:
(A) receiving, from a user, an image of at least one user age-verifying document and at least one first real-time user biometric artifact;
(B) verifying, by one or more computer systems, based at least in part on the image of the at least one user age-verifying document and/or on the at least one first real-time user biometric artifact, an identity and age of the user;
(C) displaying, on a first client device associated with the user, a listing of at least one automated product locker located within a predefined radius of the user;
(D) receiving, from the first client device, an indication of a selection of a first at least one automated product locker;
(E) displaying, on the first client device, a listing of at least one age-restricted product available for sale by the first at least one automated product locker;
(F) receiving, from the first client device, an indication of a selection of a first at least one age-restricted product;
(G) receiving payment, by one or more computer systems, from the user for the purchase of the first at least one age-restricted product;
(H) providing, at the at the first at least one automated product lockers, a code unique to the user;
(I) receiving, from the first client device, an input of the code;
(J) verifying, by one or more computer systems, that the code provided in (G) corresponds to the input of the code received in (H);
(K) receiving, from the first client device, at least one second real-time user biometric artifact;
(L) determining, by one or more computer systems, if the at least one first real-time user biometric artifact corresponds to the at least one second real-time user biometric artifact;
(M) in response to a positive determination in (K) that the at least one first real-time user biometric artifact corresponds to the at least one second real-time user biometric artifact, by the first at least one automated product lockers, dispensing the first at least one age-restricted product.

6. The method of claim 5 further comprising:
(F)(1) displaying, on the first client device, a street address and/or directions to a location of the first at least one automated product locker.

7. The method of claim 5 wherein the at least one first real-time user biometric artifact and the at least one second real-time user biometric artifact each include at least one selfie of the user.

8. The method of claim 5 wherein the first at least one age-restricted product includes a tobacco-related product.
